(19) United States
(12) Patent Application Publication
(10) Pub. No.: US 2025/0219520 A1
(43) Pub. Date: Jul. 3, 2025

(54) VIBRATION GENERATOR

(71) Applicant: ALPS ALPINE CO., LTD., Tokyo (JP)

(72) Inventor: Yusuke KAZASHI, Miyagi (JP)

(21) Appl. No.: 19/084,080

(22) Filed: Mar. 19, 2025

Related U.S. Application Data
(63) Continuation of application No. PCT/JP2023/033650, filed on Sep. 15, 2023.

(30) Foreign Application Priority Data
Nov. 1, 2022 (JP) 2022-175543

(51) Int. Cl. H02K 33/18

(52) U.S. Cl. CPC H02K 33/18

(57) ABSTRACT

A vibration generator includes: a fixed-side member; a movable-side member; an elastic support configured to support the movable-side member to vibrate in a left-right direction with respect to the fixed-side member; and a driver configured to impart a vibration force in the left-right direction to the movable-side member. The driver is provided with a fixed-side magnetic field generator included in the fixed-side member and a movable-side magnetic field generator included in the movable-side member.

### CROSS-REFERENCE TO RELATED APPLICATIONS

This application is a continuation application of International Application No. PCT/JP2023/033650, filed on Sep. 15, 2023, and designated the U.S., which is based upon and claims priority to Japanese Patent Application No. 2022-175543, filed on Nov. 1, 2022, the entire contents of which are incorporated herein by reference.

### BACKGROUND

### 1. Field of the Invention

The present disclosure relates to a vibration generator.

### 2. Description of the Related Art

Conventionally, a vibration motor (vibration generator) includes a plate spring as an elastic member (elastic support) on a left side and a right side of a movable part which vibrates in a left-right direction (see Japanese Laid-Open Patent Application No. 2010-207725).

### SUMMARY

A vibration generator according to an embodiment of the present disclosure includes: a fixed-side member; a movable-side member; an elastic support configured to support the movable-side member to vibrate in a left-right direction with respect to the fixed-side member; and a driver configured to impart a vibration force in the left-right direction to the movable-side member, the driver being provided with a fixed-side magnetic field generator included in the fixed-side member and a movable-side magnetic field generator included in the movable-side member, wherein the elastic support includes a left elastic support and a right elastic support, the right elastic support includes a right fixed portion fixed to the fixed-side member, a right deforming portion having one end connected to the right fixed portion and extending in a front-rear direction, and a right standing portion extending in a vertical direction from another end of the right deforming portion, the right deforming portion deforms in a left-right direction upon vibration of the movable-side member in the left-right direction, the right standing portion moves in the left-right direction together with the movable-side member upon deformation of the right deforming portion, the movable-side member is attached to an upper end of the right standing portion, or a connecting plate portion connecting an upper end of the left elastic support and an upper end of the right elastic support, so as to be arranged on a left side of the right standing portion and at a position above an upper end of the right deforming portion, upon vibration and displacement of the movable-side member to the right side, a lower portion of the movable-side member is at a position above the right deforming portion and not interfering with the right deforming portion, the right deforming portion extends in the front-rear direction from a front end or a rear end of the right standing portion, and a length of the right deforming portion in the front-rear direction is greater than a length of the right standing portion in the front-rear direction.

### BRIEF DESCRIPTION OF THE DRAWINGS

FIG. 1 is a diagram illustrating a configuration example of a vibration generator;

FIG. 2 is a diagram illustrating an exploded perspective view of the vibration generator;

FIG. 3 is a diagram illustrating a six-sided view of an elastic support;

FIG. 4 is a diagram illustrating a perspective view of a movable-side member and the elastic support;

FIG. 5 is a diagram illustrating a front view and a bottom view of the movable-side member and the elastic support;

FIG. 6 is a diagram illustrating a top view and a cross-sectional view of the vibration generator;

FIG. 7 is a diagram illustrating top views of a coil, the movable-side member, and the elastic support;

FIG. 8 is a diagram illustrating front views of the coil, the movable-side member, and the elastic support; and

FIG. 9 is a diagram illustrating perspective views of the movable-side member and the elastic support.

### DETAILED DESCRIPTION OF THE DISCLOSURE

The structure disclosed in Japanese Laid-Open Patent Application No. 2010-207725 may result in the vibration generator having an increased size in a vibration direction.

Therefore, a vibration generator capable of suppressing a size increase in the vibration direction has been desired.

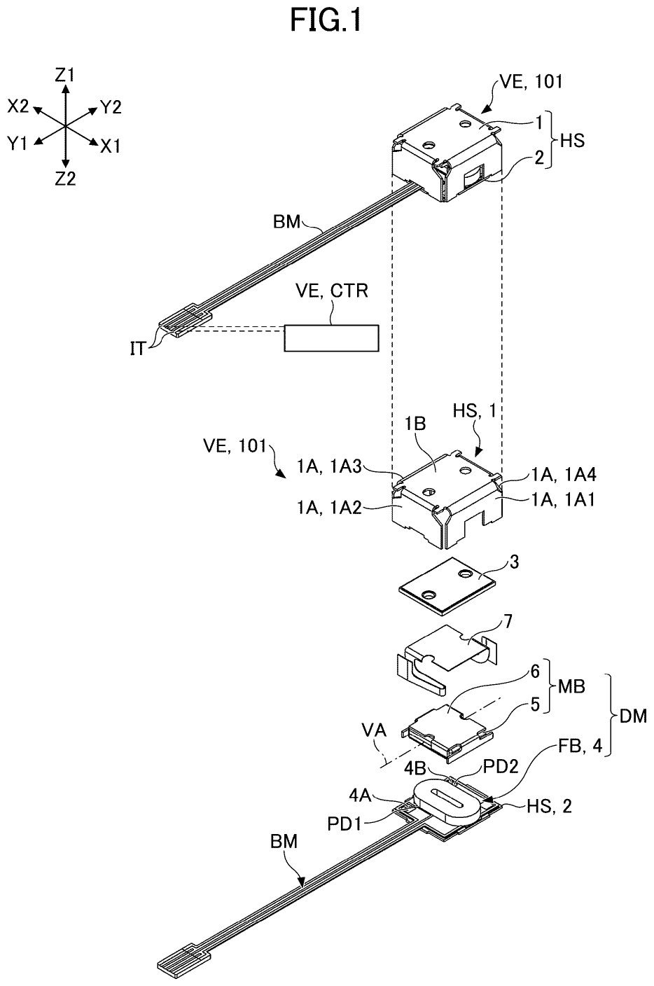

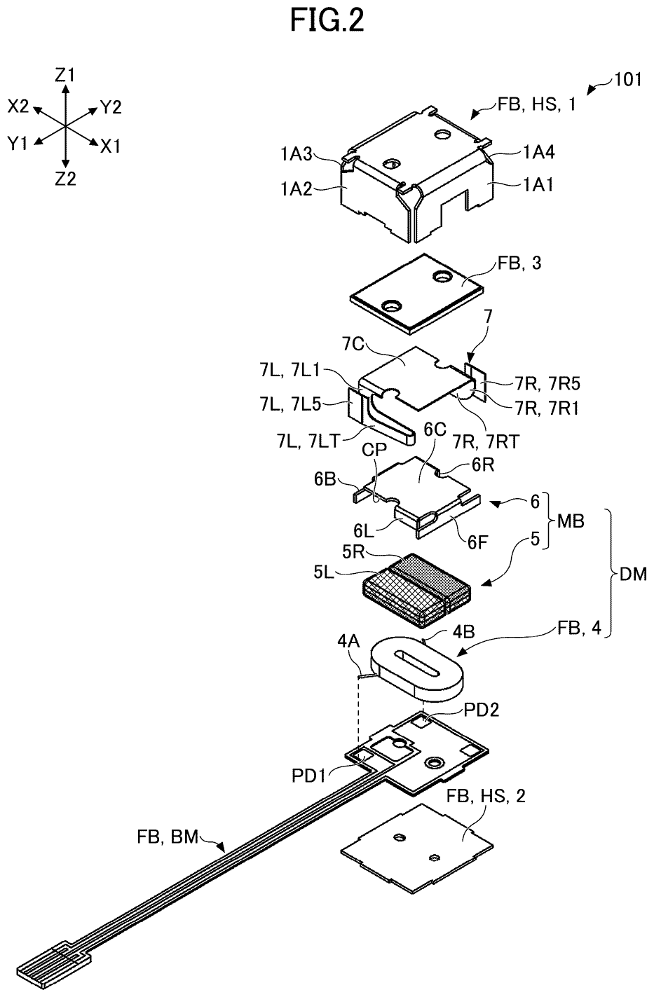

A vibration generator 101 according to an embodiment of the present disclosure will be described in the following with reference to the drawings. FIG. 1 is a diagram illustrating a configuration example of the vibration generator 101. Specifically, the upper diagram of FIG. 1 is a perspective view of the vibration generator 101, and the lower diagram of FIG. 1 is an exploded perspective view of the vibration generator 101. FIG. 2 is a further detailed exploded perspective view of the vibration generator 101.

In FIGS. 1 and 2, X1 represents one direction of an X-axis constituting a three-dimensional orthogonal coordinate system, and X2 represents the other direction of the X-axis. Y1 represents one direction of a Y-axis constituting the three-dimensional orthogonal coordinate system, and Y2 represents the other direction. Similarly, Z1 represents one direction of a Z-axis constituting the three-dimensional orthogonal coordinate system, and Z2 represents the other direction of the Z-axis. In the present embodiment, an X1 side of the vibration generator 101 corresponds to the front side (front) of the vibration generator 101, and an X2 side of the vibration generator 101 corresponds to the rear side (rear) of the vibration generator 101. A Y1 side of the vibration generator 101 corresponds to the left side of the vibration generator 101, and a Y2 side of the vibration generator 101 corresponds to the right side of the vibration generator 101. A Z1 side of the vibration generator 101 corresponds to the upper side of the vibration generator 101, and a Z2 side of the vibration generator 101 corresponds to the lower side of the vibration generator 101. The same applies to other drawings.

A vibrator VE includes a controller CTR and the vibration generator 101. The vibration generator 101 is inserted into an elongated cylinder such as a stylus, for example, and arranged to vibrate in a radial direction (transverse direction) of the cylinder. Therefore, the vibration generator 101 can be configured to have minimal length in the vibration direction, while still achieving the desired vibration power. Specifically, the vibration generator 101 includes a housing HS as a box casing, a movable-side member MB cased in the housing HS, a non-magnetic metal plate 3 attached to the housing HS, and a coil 4 attached to the housing HS via an insulating substrate BM. The housing HS, the non-magnetic metal plate 3, and the coil 4 constitute a fixed-side member FB. The controller CTR is connected to an input terminal IT provided on the insulating substrate BM fixed to the housing HS via an adhesive. In the present embodiment, the insulating substrate BM is a combination of a flexible substrate and a rigid substrate. However, the insulating substrate BM may be a rigid flexible substrate or the like. Dashed lines connecting the controller CTR and the input terminal IT provided on the insulating substrate BM in the upper drawing of FIG. 1 schematically illustrate that the controller CTR and the input terminal IT are electrically connected.

As illustrated in the upper drawing of FIG. 1, the housing HS has a substantially rectangular parallelepiped outer shape, and is configured such that areas of the surfaces (upper and lower surfaces) parallel to an XY plane are larger than those of the other surfaces. In the present embodiment, the housing HS includes a cover 1 and a base plate 2. The cover 1 is formed of a non-magnetic metal such as an austenitic stainless steel. However, the cover 1 may be formed of a synthetic resin or a magnetic metal.

As illustrated in the lower diagram of FIG. 1, the cover 1 is configured to form five surfaces (top, front, left, rear, and right surfaces) of the housing HS by bending a single metal plate. Specifically, the cover 1 includes a substantially rectangular cylindrical portion 1A and a substantially rectangular flat top plate 1B. The cylindrical portion 1A includes a front plate 1A1, a left plate 1A2, a rear plate 1A3, and a right plate 1A4. More specifically, the cylindrical portion 1A includes the front plate 1A1 and the rear plate 1A3 facing with each other, and the left plate 1A2 and the right plate 1A4 facing with each other and perpendicular to the front plate 1A1 and the rear plate 1A3.

The base plate 2 is configured to form a lower surface (bottom surface) of the housing HS. In the present embodiment, the base plate 2 constitutes a bottom plate having a substantially rectangular flat plate shape. In the illustrated example, the base plate 2 is formed of a magnetic metal and functions as a fixed-side magnetic member. The base plate 2 as the fixed-side magnetic member is configured to control a path of magnetic field lines of a magnetic field generated by a movable-side magnetic field generator 5. The base plate 2 as the fixed-side magnetic member is a member constituting a driver DM. However, the base plate 2 may be formed of a non-magnetic metal such as an austenitic stainless steel.

The cover 1 is fixed to the base plate 2. Specifically, the cover 1 is joined to the base plate 2 by welding together the lower end of the cylindrical portion 1A and the base plate 2. The lower end of the cylindrical portion 1A and the base plate 2 may be joined together by brazing, adhesive, caulking, or the like. The insulating substrate BM is bonded to an upper surface of the base plate 2 by an adhesive.

The non-magnetic metal plate 3 is fixed to a ceiling surface of the cover 1. For example, the non-magnetic metal plate 3 may be fixed to the ceiling surface of the cover 1 by a double-sided tape, adhesive, caulking, or the like. In the illustrated example, the non-magnetic metal plate 3 is a copper plate and fixed to the ceiling surface of the cover 1 by an adhesive. The non-magnetic metal plate 3 may be formed by including copper or aluminum.

The coil 4 is an example of a fixed-side magnetic field generator and is configured to generate a magnetic field while being fixed to the housing HS. The coil 4 is a member constituting the driver DM. In the present embodiment, the coil 4 is a winding coil formed by winding a conductive wire whose surface is covered with an insulating material, and is fixed to the insulating substrate BM with an adhesive. In FIGS. 1 and 2, a detailed winding state of the conductive wire is omitted for the sake of clarity. The same applies to other drawings illustrating the coil 4.

Specifically, the coil 4 is arranged such that one end (first end 4A) is connected to a first conductor pad PD1 formed on an upper surface of the insulating substrate BM, and the other end (second end 4B) is connected to a second conductor pad PD2 formed on the upper surface of the insulating substrate BM, as illustrated in the lower drawing of FIG. 1.

The controller CTR is configured to control the movement of the movable-side member MB. In the present embodiment, the controller CTR is a device including such as an electronic circuit and a nonvolatile memory, and is configured to control the direction and the magnitude of the current flowing through the coil 4. The controller CTR may be configured to control the direction and the magnitude of the current flowing through the coil 4 in response to a control command from an external device such as a computer, or may be configured to control the direction and the magnitude of the current flowing through the coil 4 without receiving a control command from an external device. For example, the controller CTR may be a microcomputer provided with a CPU. In the present embodiment, the controller CTR is installed outside the housing HS, but may be installed inside the housing HS.

The movable-side member MB is configured to vibrate the housing HS. In the present embodiment, the movable-side member MB is configured to vibrate the housing HS by reciprocating while being attached to the housing HS via an elastic support 7.

Specifically, the movable-side member MB includes a movable-side magnetic field generator 5 and a movable-side magnetic member 6, and is configured to be elastically supported by the elastic support 7. More specifically, the movable-side member MB has a predetermined natural frequency and is configured to reciprocate (vibrate) with respect to the housing HS along a vibration axis VA (see the lower diagram in FIG. 1) extending in a predetermined direction (Y-axis direction).

The movable-side magnetic field generator 5 is configured to generate a magnetic field while being capable of reciprocating (vibrating) with respect to the housing HS. The movable-side magnetic field generator 5 is a member constituting the driver DM. In the present embodiment, the movable-side magnetic field generator 5 includes a left magnet 5L and a right magnet 5R both magnetized to two poles in a Z-axis direction, as illustrated in FIG. 2. In FIG. 2, for the sake of clarity, a cross pattern is applied to S-pole portions of the movable-side magnetic field generator 5, and a dot pattern is applied to N-pole portions of the movable-side magnetic field generator 5. The same applies to other figures illustrating the polarity of the movable-side magnetic field generator 5.

The movable-side magnetic member 6 is a member used to attach the movable-side magnetic field generator 5 to the elastic support 7. In the illustrated example, the movable-side magnetic member 6 is welded to the elastic support 7. The movable-side magnetic member 6 is configured to control the path of the magnetic field lines of the magnetic field generated by the movable-side magnetic field generator 5. The movable-side magnetic member 6 constitutes the driver DM. In the present embodiment, the movable-side magnetic member 6 includes a center portion 6C to which the movable-side magnetic field generator 5 is attached, a posterior portion 6B disposed on the rear side of the center portion 6C, an anterior portion 6F disposed on the front side of the center portion 6C, a left side portion 6L disposed on the left side of the center portion 6C, and a right side portion 6R disposed on the right side of the center portion 6C. In the example as illustrated in FIGS. 1 and 2, the movable-side magnetic field generator 5 is adsorbed on a ceiling surface CP of the movable-side magnetic member 6. The movable-side magnetic field generator 5 and the movable-side magnetic member 6 may be fixed to each other by an adhesive.

The driver DM is an example of a vibration force generator and is configured such that the movable-side member MB can vibrate along the vibration axis VA. In the present embodiment, the driver DM is an electromagnetic driver and includes the base plate 2 (fixed-side magnetic member), the coil 4 (fixed-side magnetic field generator), the movable-side magnetic field generator 5, and the movable-side magnetic member 6. Specifically, the driver DM is configured such that the movable-side member MB (movable-side magnetic field generator 5) elastically supported by the elastic support 7 can vibrate along the vibration axis VA by utilizing the Lorentz force corresponding to the direction and the magnitude of the current supplied to the coil 4 under the control of the controller CTR.

The elastic support 7 is arranged between the fixed-side member FB (housing HS) and the movable-side member MB such that the movable-side member MB can be elastically supported. In the present embodiment, the elastic support 7 is a plate spring formed of a metal plate and includes a left elastic support 7L attached to an inner surface (Y2-side surface) of the left plate 1A2 of the housing HS, a right elastic support 7R attached to an inner surface (Y1-side surface) of the right plate 1A4 of the housing HS, and a center portion 7C provided between the left elastic support 7L and the right elastic support 7R. In the illustrated example, the center portion 7C functions as a connecting plate portion connecting the left elastic support 7L and the right elastic support 7R. Note that the center portion 7C may be omitted. In this case, the left elastic support 7L and the right elastic support 7R are independent members and are separately fixed to the movable-side member MB.

The elastic support 7 may include a reinforcing plate portion for suppressing deformation of the center portion 7C. Specifically, the reinforcing plate portion includes, for example, at least one of a front extending portion extending downward from a front edge of the center portion 7C or a rear side extending downward from a rear edge of the center portion 7C.

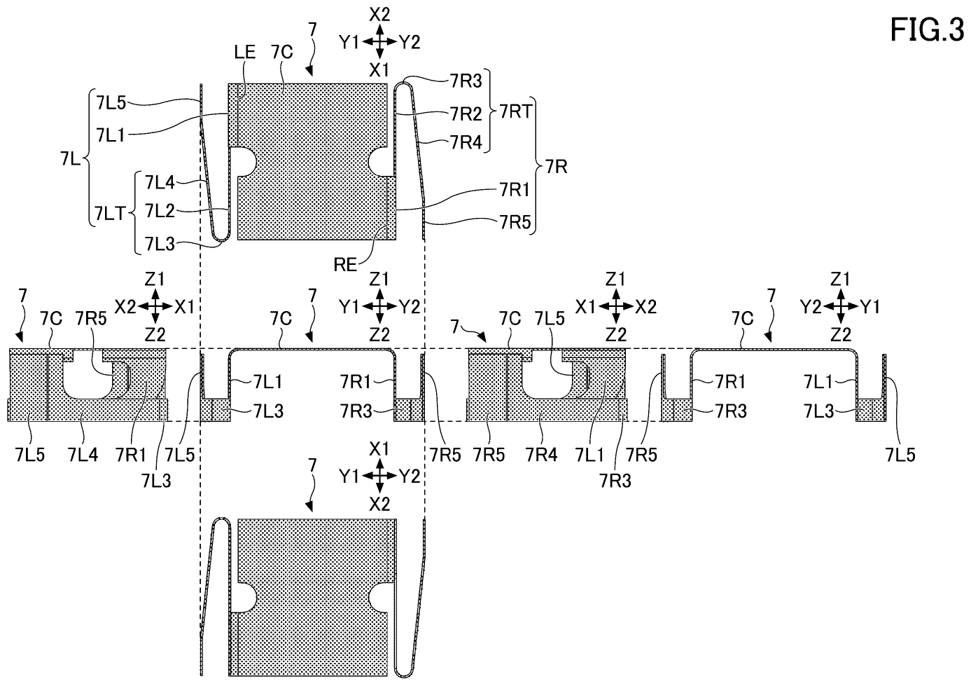

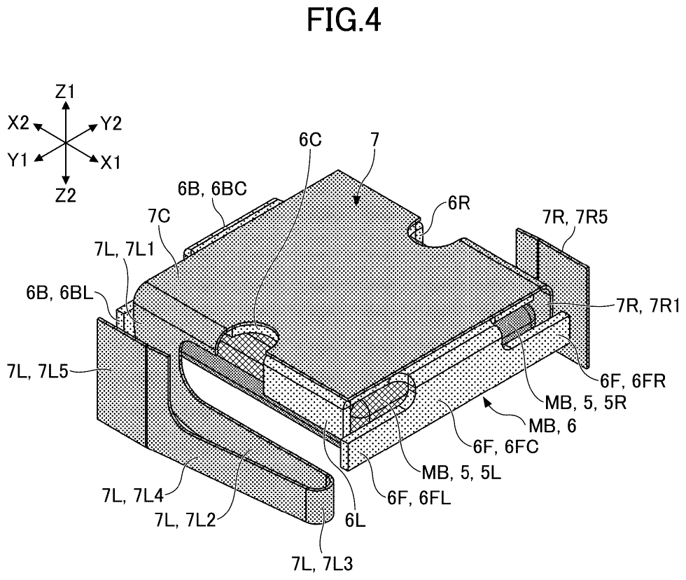

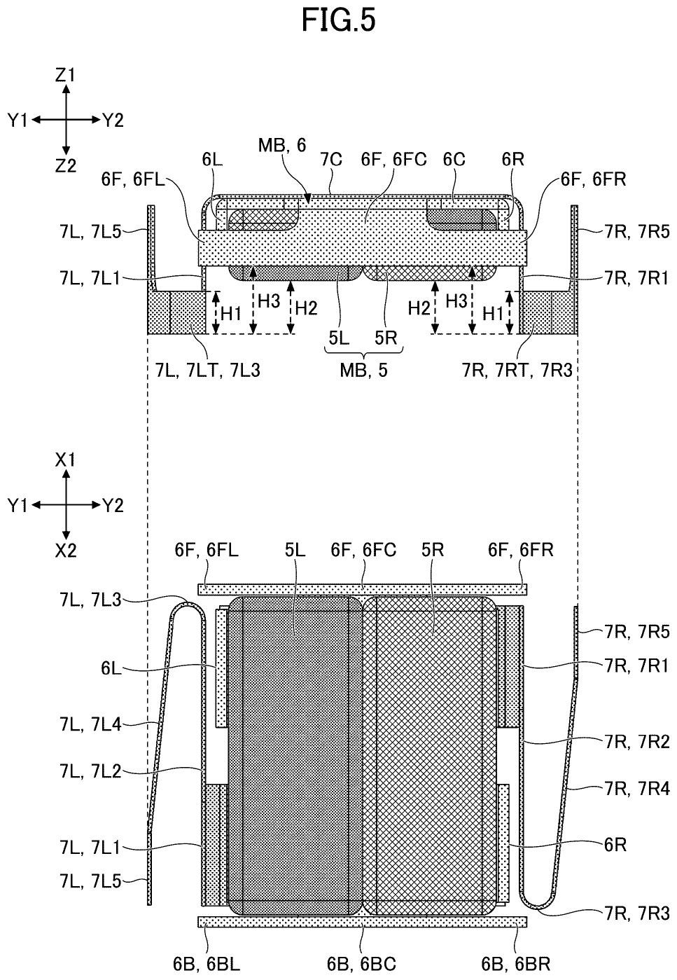

The elastic support 7 will now be described in detail with reference to FIGS. 3, 4, and 5. FIG. 3 is a six-sided view of the elastic support 7. FIGS. 4 and 5 are views of the elastic support 7 supporting the movable-side member MB (the movable-side magnetic field generator 5 and the movable-side magnetic member 6) so as to be capable of reciprocating. Specifically, FIG. 4 is a perspective view of the movable-side magnetic field generator 5, the movable-side magnetic member 6, and the elastic support 7; the upper drawing of FIG. 5 is a front view of the movable-side magnetic field generator 5, the movable-side magnetic member 6, and the elastic support 7; and the lower drawing of FIG. 5 is a bottom view of the movable-side magnetic field generator 5, the movable-side magnetic member 6, and the elastic support 7.

The center portion 7C is configured to be fixed to an upper surface of the movable-side magnetic member 6. In the present embodiment, a lower surface of the center portion 7C is fixed to the upper surface of the movable-side magnetic member 6 by welding.

The left elastic support 7L is a member that elastically supports the movable-side member MB and includes a left standing portion 7L1, a first left deforming portion 7L2, a left bent portion 7L3, a second left deforming portion 7L4, and a left fixed portion 7L5. The left standing portion 7L1 is a portion that connects a left end LE of the center portion 7C (see the top view in FIG. 3) and the first left deforming portion 7L2. In the present embodiment, the left standing portion 7L1 is formed by bending the left end LE of the center portion 7C extending in an X-axis direction as a crease. The left standing portion 7L1 includes a portion formed straight in a front view. In the present embodiment, the left standing portion 7L1 extends vertically downward (in a Z2 direction) with respect to the center portion 7C. The first left deforming portion 7L2 is a portion formed straight in a top view. In the present embodiment, the first left deforming portion 7L2 extends forward (in an X1 direction) from the left standing portion 7L1. The left bent portion 7L3 extends leftward (in a Y1 direction) from the front end of the first left deforming portion 7L2 and curves to project forward.

In the present embodiment, the left bent portion 7L3 is configured to have a U-shape in a top view such that the stress acting on the left bent portion 7L3 is distributed over a wide range. The second left deforming portion 7L4 is a straight portion extending rearward (in an X2 direction) from the left end of the left bent portion 7L3. The left fixed portion 7L5 is a portion fixed to the housing HS. In the present embodiment, the left fixed portion 7L5 extends rearward (in the X2 direction) from the rear end of the second left deforming portion 7L4 and to be parallel with the left plate 1A2 of the cover 1, and is fixed to the left plate 1A2 by welding. However, the left fixed portion 7L5 may be fixed to other portions of the housing HS such as the front plate 1A1, the rear plate 1A3, the top plate 1B, or the base plate 2 by welding or the like. The first left deforming portion 7L2, the left bent portion 7L3, and the second left deforming portion 7L4 are also referred to as a left deforming portion 7LT (see the top view in FIG. 3), which is a portion deformed according to the reciprocating motion of the movable-side member MB.

The right elastic support 7R is a member that elastically supports the movable-side member MB and includes a right standing portion 7R1, a first right deforming portion 7R2, a right bent portion 7R3, a second right deforming portion 7R4, and a right fixed portion 7R5. The right standing portion 7R1 is a portion that connects a right end RE of the center portion 7C (see the top view in FIG. 3) and the first right deforming portion 7R2. In the present embodiment, the right standing portion 7R1 is formed by bending the right end RE of the center portion 7C extending in the X-axis direction as a crease. The right standing portion 7R1 includes a portion formed straight in a front view. In the present embodiment, the right standing portion 7R1 extends vertically downward (in the Z2 direction) with respect to the center portion 7C. The first right deforming portion 7R2 is a portion formed straight in a top view. In the present embodiment, the first right deforming portion 7R2 is configured to extend rearward (in the X2 direction) from the right standing portion 7R1. The right bent portion 7R3 is configured to extend rightward (in a Y2 direction) from the rear end of the first right deforming portion 7R2 and curve to project rearward. In the present embodiment, the right bent portion 7R3 is configured to have a U-shape in a top view such that the stress acting on the right bent portion 7R3 is distributed over a wide range. The second right deforming portion 7R4 is a straight portion extending forward (in the X1 direction) from the right end of the right bent portion 7R3. The right fixed portion 7R5 is a portion fixed to the housing HS. In the present embodiment, the right fixed portion 7R5 extends forward (in the X1 direction) from the front end of the second right deforming portion 7R4 and to be parallel with the right plate 1A4 of the cover 1, and is fixed to the right plate 1A4 by welding. However, the right fixed portion 7R5 may be fixed to other portions of the housing HS such as the front plate 1A1, the rear plate 1A3, the top plate 1B, or the base plate 2 by welding or the like. The first right deforming portion 7R2, the right bent portion 7R3, and the second right deforming portion 7R4 are also referred to as a right deforming portion 7RT (see the top view in FIG. 3), which is a portion deformed according to the reciprocating motion of the movable-side member MB.

The left side portion 6L of the movable-side magnetic member 6 is configured such that the movable-side magnetic field generator 5 (left magnet 5L) adsorbed on the movable-side magnetic member 6 fixed to the center portion 7C can be restricted from moving leftward with respect to the movable-side magnetic member 6. The right side portion 6R of the movable-side magnetic member 6 is configured such that the movable-side magnetic field generator 5 (right magnet 5R) adsorbed on the movable-side magnetic member 6 fixed to the center portion 7C can be restricted from moving rightward with respect to the movable-side magnetic member 6. The posterior portion 6B of the movable-side magnetic member 6 is configured such that the movable-side magnetic field generator 5 adsorbed on the movable-side magnetic member 6 fixed to the center portion 7C can be restricted from moving rearward with respect to the movable-side magnetic member 6. The anterior portion 6F of the movable-side magnetic member 6 is configured such that the movable-side magnetic field generator 5 adsorbed on the movable-side magnetic member 6 fixed to the center portion 7C can be restricted from moving forward with respect to the movable-side magnetic member 6.

Specifically, the posterior portion 6B includes a central posterior portion 6BC, a left posterior portion 6BL, and a right posterior portion 6BR, and the anterior portion 6F includes a central anterior portion 6FC, a left anterior portion 6FL, and a right anterior portion 6FR. The left posterior portion 6BL and the left anterior portion 6FL are configured such that they function as left stoppers for restricting the movement of the movable-side member MB to the left (Y1 direction), and the right posterior portion 6BR and the right anterior portion 6FR are configured such that they function as right stoppers for restricting the movement of the movable-side member MB to the right (Y2 direction). Specifically, the left posterior portion 6BL and the left anterior portion 6FL are configured such that when the movable-side member MB moves leftward by a predetermined distance, they contact the inner surface of the left plate 1A2 of the cylindrical portion 1A, and can suppress further movement of the movable-side member MB to the left. Furthermore, the right posterior portion 6BR and the right anterior portion 6FR are configured such that when the movable-side member MB moves rightward by a predetermined distance, they contact the inner surface of the right plate 1A4 of the cylindrical portion 1A, thereby suppressing further movement of the movable-side member MB to the right.

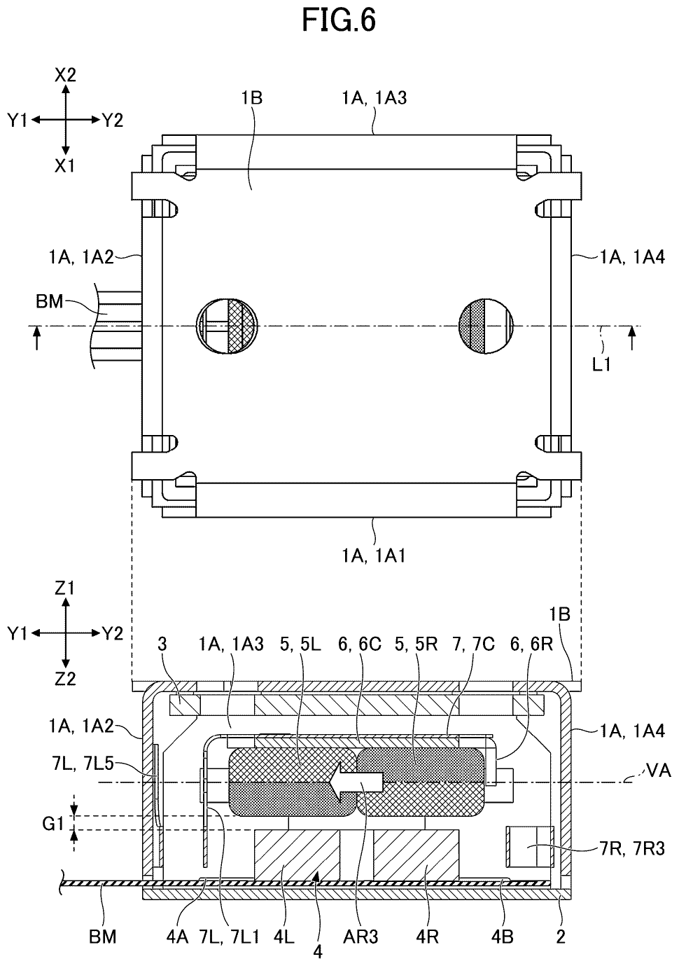

Next, the reciprocating motion of the movable-side member MB by using the driver DM will be described with reference to FIGS. 6, 7, and 8.

FIG. 6 is a detailed view of the vibration generator 101. More specifically, the upper drawing of FIG. 6 is a top view of the vibration generator 101, and the lower drawing of FIG. 6 is a vertical cross-sectional view of the vibration generator 101 taken along an imaginary plane parallel to a YZ plane including a dot-and-dash line L1 in the upper drawing of FIG. 6 when viewed from the X1 side. More specifically, the lower drawing of FIG. 6 illustrates a state when the vibration generator 101 is in an initial state. The initial state of the vibration generator 101 means a state of the vibration generator 101 when no current is supplied to the coil 4.

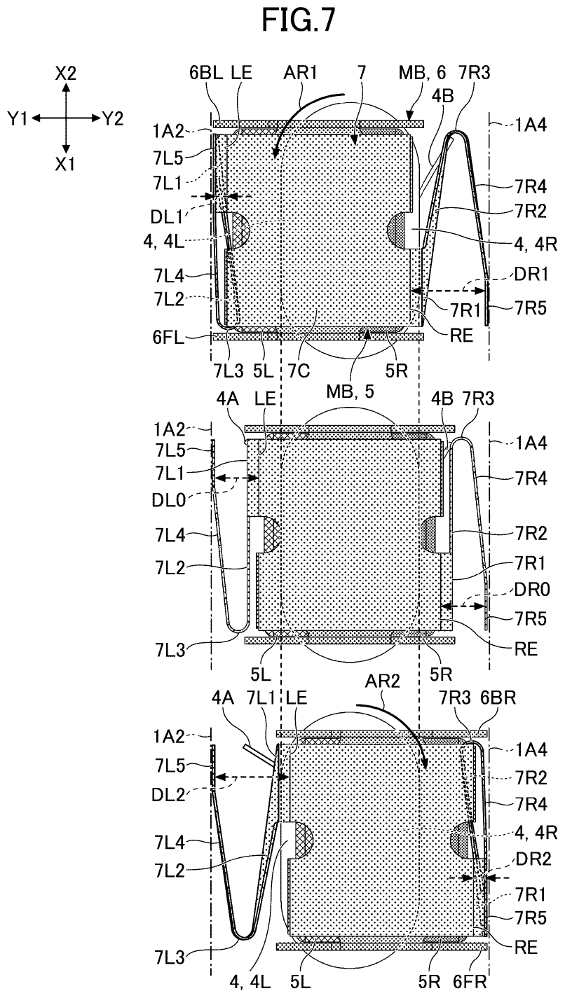

FIG. 7 is a diagram illustrating top views of the coil 4, the movable-side member MB (the movable-side magnetic field generator 5 and the movable-side magnetic member 6), and the elastic support 7. More specifically, the upper drawing of FIG. 7 illustrates a state when the movable-side member MB is moved to the left (Y1 direction), the middle drawing of FIG. 7 illustrates a state when the movable-side member MB is in a neutral position (when it is not moved), and the lower drawing of FIG. 7 illustrates a state when the movable-side member MB is moved to the right (Y2 direction). In FIG. 7, portions of the coil 4 and the elastic support 7, which cannot be actually viewed as they are hidden by the movable-side member MB, are indicated by hidden lines (broken lines) for ease of explanation.

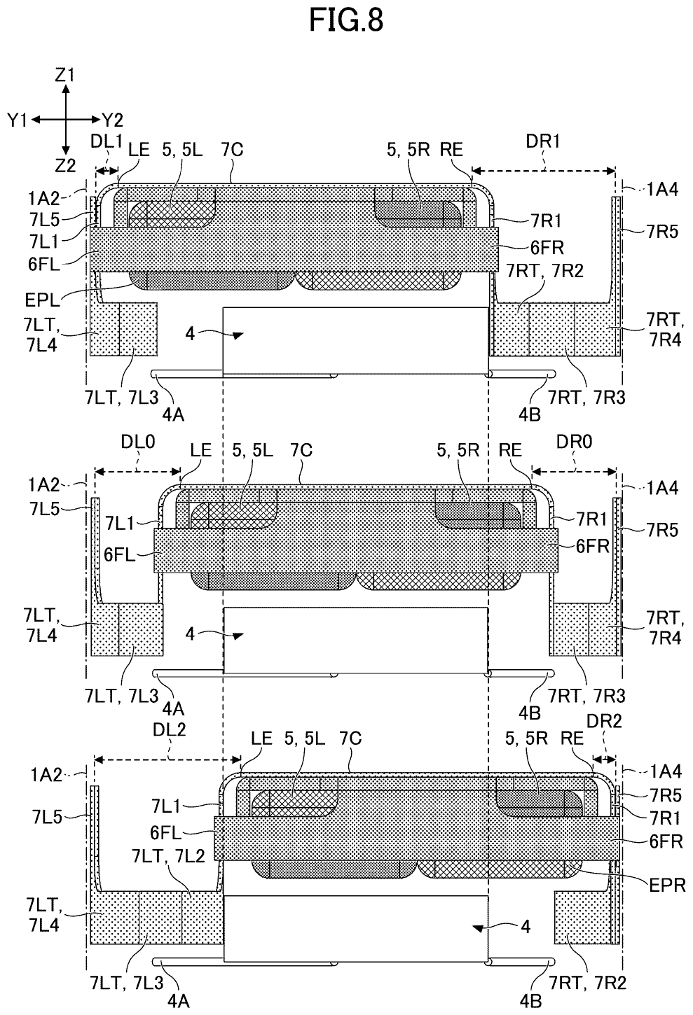

FIG. 8 is a diagram illustrating front views of the coil 4, the movable-side member MB (the movable-side magnetic field generator 5 and the movable-side magnetic member 6), and the elastic support 7. Specifically, the upper drawing of FIG. 8 illustrates a state when the movable-side member MB is moved to the left (Y1 direction), the middle drawing of FIG. 8 illustrates a state when the movable-side member MB is in the neutral position (when it is not moved), and the lower drawing of FIG. 8 illustrates a state when the movable-side member MB is moved to the right (Y2 direction).

For example, as illustrated in the lower drawing of FIG. 6, the lower half of the left magnet 5L constituting the movable-side magnetic field generator 5 is magnetized to the N pole, and the upper half is magnetized to the S pole. The lower half of the right magnet 5R constituting the movable-side magnetic field generator 5 is magnetized to the S pole, and the upper half is magnetized to the N pole.

When the current flows from the first end 4A to the second end 4B of the coil 4, the current flows counterclockwise in a top view as indicated by an arrow AR1 in the upper drawing of FIG. 7. In this case, in the initial state, the current flows from the rear side (X2 side) to the front side (X1 side) in a top view in a left bundle portion 4L of the coil 4 facing the left magnet 5L in the vertical direction and extending linearly in the front-rear direction, such that a force to move the left magnet 5L leftward (Y1 direction) acts on the left magnet 5L as a reaction force of the Lorentz force.

Furthermore, in the initial state, the current flows from the front side (X1 side) to the rear side (X2 side) in a top view of a right bundle portion 4R of the coil 4 facing the right magnet 5R in the vertical direction and extending linearly along the front-rear direction, such that a force to move the right magnet 5R to the left (Y1 direction) acts as a reaction force of the Lorentz force.

As a result, the movable-side member MB is biased to the left (Y1 direction) as indicated by a block arrow AR3 in the lower diagram of FIG. 6, and moves to the left as illustrated in the upper diagram of FIG. 7 and the upper diagram of FIG. 8. When the movable-side member MB moves to the left by a predetermined distance, the left anterior portion 6FL and the left posterior portion 6BL of the movable-side magnetic member 6 and the inner surface of the left plate 1A2 of the cylindrical portion 1A contact each other, thereby restricting further movement of the movable-side member MB to the left. In FIGS. 7 and 8, the position of the left plate 1A2 of the cylindrical portion 1A is indicated by a dot-and-dash line for ease of explanation. The controller CTR is typically configured to vibrate the movable-side member MB such that the left anterior portion 6FL and the left posterior portion 6BL of the movable-side magnetic member 6 do not contact the inner surface of the left plate 1A2 of the cylindrical portion 1A.

In this case, as illustrated in the upper drawing of FIG. 7, the left elastic support 7L is compressed such that a distance DL1 in the left-right direction (Y-axis direction) between the left end LE of the center portion 7C and the left fixed portion 7L5 is smaller than a distance DL0 in the initial state (see the middle drawing of FIG. 7). The right elastic support 7R is stretched such that a distance DR1 in the left-right direction (Y-axis direction) between the right end RE of the center portion 7C and the right fixed portion 7R5 is greater than a distance DR0 in the initial state.

In contrast to this, when the current flows from the second end 4B to the first end 4A of the coil 4, the current flows clockwise in the top view as indicated by an arrow AR2 in the lower drawing of FIG. 7. In this case, since the current flows from the front side (X1 side) to the rear side (X2 side) in the upper view in the left bundle portion 4L which faces the left magnet 5L of the coil 4 in the vertical direction in the initial state, a force to move the left magnet 5L to the right (Y2 direction) as a reaction force of the Lorentz force acts on the left magnet 5L. In addition, since the current flows from the rear side (X2 side) to the front side (X1 side) in the upper view in the right bundle portion 4R which faces the right magnet 5R of the coil 4 in the vertical direction in the initial state, a force to move the right magnet 5R to the right (Y2 direction) acts as a reaction force of the Lorentz force.

As a result, the movable-side member MB is biased to the right (Y2 direction) and moves to the right as illustrated in the lower diagram of FIG. 7 and the lower diagram of FIG. 8. When the movable-side member MB moves to the right by a predetermined distance, the right anterior portion 6FR and the right posterior portion 6BR of the movable-side magnetic member 6 and the inner surface of the right plate 1A4 of the cylindrical portion 1A contact each other, and further movement of the movable-side member MB to the right is restricted. In FIGS. 7 and 8, the position of the right plate 1A4 of the cylindrical portion 1A is indicated by a dot-and-dash line for ease of explanation. The controller CTR is typically configured to vibrate the movable-side member MB such that the right anterior portion 6FR and the right posterior portion 6BR of the movable-side magnetic member 6 do not contact the inner surface of the right plate 1A4 of the cylindrical portion 1A.

In this case, the left elastic support 7L is extended such that a distance DL2 in the left-right direction (Y-axis direction) between the left end LE of the center portion 7C and the left fixed portion 7L5 is greater than the distance DL0 in the initial state (see the middle drawing in FIG. 7), as illustrated in the lower diagram in FIG. 7. The right elastic support 7R is compressed such that a distance DR2 in the left-right direction (Y-axis direction) between the right end RE of the center portion 7C and the right fixed portion 7R5 is smaller than the distance DR0 in the initial state.

The controller CTR induces alternating transitions between the state illustrated in the upper drawing of FIG. 7 and the state illustrated in the lower drawing of FIG. 7 by repeatedly reversing the direction of the current flowing through the coil 4 at a cycle corresponding to the natural frequency of the elastic support 7, for example. These transitions necessarily pass through the central state illustrated in the middle drawing of FIG. 7.

Specifically, the controller CTR stops supplying the current to the coil 4 when the vibration generator 101 enters the state as illustrated in the upper drawing of FIG. 7. When the supply of the current to the coil 4 is stopped, the Lorentz force and its reaction force disappear. At this time, the movable-side member MB is pushed back to the right (Y2 direction) by a restoring force of the elastic support 7. The same applies when the vibration generator 101 enters the state as illustrated in the lower drawing of FIG. 7.

Alternatively, the controller CTR may drive the movable-side member MB in a reciprocating left-right direction by intermittently applying the current the current to the coil 4 without reversing the direction of the current flowing through the coil 4.

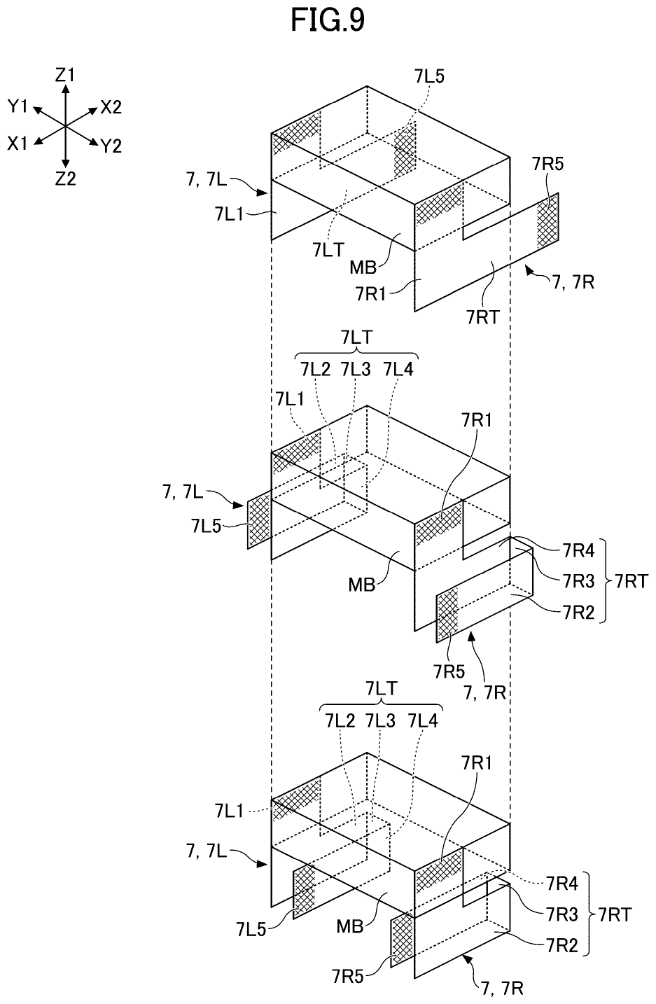

Next, another configuration example of the elastic support 7 configured to elastically support the movable-side member MB will be described with reference to FIG. 9. FIG. 9 is a diagram illustrating perspective views of another configuration example of the elastic support 7 for elastically supporting the movable-side member MB. Specifically, in FIG. 9, three other configuration examples of the elastic support 7 for elastically supporting the movable-side member MB are illustrated. In FIG. 9, a portion of each of the elastic support 7 and the movable-side member MB, which are hidden by itself or other members, is indicated by a hidden line (broken line) for ease of explanation. In FIG. 9, a cross pattern is applied to welding portions for ease of explanation.

The elastic support 7 as illustrated in the upper drawing of FIG. 9 differs from the elastic support 7 as illustrated in FIG. 3 in that the elastic support 7 does not include a center portion and bent portions (left bent portion and right bent portion), but is the same as the elastic support 7 as illustrated in FIG. 3 in other respects.

The elastic support 7 as illustrated in the middle drawing of FIG. 9 differs from the elastic support 7 as illustrated in FIG. 3 in that the elastic support 7 does not include the center portion and the left bent portion 7L3 is arranged to project rearward in the same manner as the right bent portion 7R3, but is the same as the elastic support 7 as illustrated in FIG. 3 in other respects.

The elastic support 7 as illustrated in the lower drawing of FIG. 9 differs from the elastic support 7 as illustrated in FIG. 3 in that the elastic support 7 does not include the center portion, the left fixed portion 7L5 is disposed inward (right side, Y2 side) of the left standing portion 7L1, and the right fixed portion 7R5 is disposed inward (left side, Y1 side) of the right standing portion 7R1, but is the same as the elastic support 7 as illustrated in FIG. 3 in other respects. In the example as illustrated in the lower drawing of FIG. 9, the base plate 2 may be configured such that portions (not illustrated) to be welded to the left fixed portion 7L5 and the right fixed portion 7R5 respectively project upward from the upper surface of the base plate 2. Alternatively, each of the left fixed portion 7L5 and the right fixed portion 7R5 may include portions (not illustrated) extending parallel to the upper surface of the base plate 2 to be welded to the upper surface of the base plate 2.

As described above, the vibration generator 101 according to the embodiment of the present disclosure, as illustrated in FIG. 2, includes: the fixed-side member FB and the movable-side member MB; the elastic support 7 configured to support the movable-side member MB to vibrate in the left-right direction (Y-axis direction) with respect to the fixed-side member FB; the fixed-side magnetic field generator (coil 4) included in the fixed-side member FB; and the driver DM including the movable-side magnetic field generator 5 included in the movable-side member MB and imparting a vibration force in the left-right direction (Y-axis direction) to the movable-side member MB. The elastic support 7 includes the left elastic support 7L and the right elastic support 7R. As illustrated in the top view of FIG. 3, the right elastic support 7R may include the right fixed portion 7R5 fixed to the fixed-side member FB (cover 1), the right deforming portion 7RT having one end connected to the right fixed portion 7R5 and extending in the front-rear direction (X-axis direction), and the right standing portion 7R1 extending in the vertical direction (Z-axis direction) from the other end of the right deforming portion 7RT. As illustrated in the upper drawing of FIG. 5, the movable-side member MB (the movable-side magnetic field generator 5 and the movable-side magnetic member 6) are attached to the right elastic support 7R to be disposed on the left side (Y1 side) of the right standing portion 7R1 and at a position higher than a height H1 of the upper end of the right deforming portion 7RT. The height H1 is the distance from the lower end of the right deforming portion 7RT to the upper end of the right deforming portion 7RT in the Z-axis direction. The distance from the lower end of the right deforming portion 7RT to the movable-side magnetic field generator 5 (right magnet 5R) in the Z-axis direction is a height H2 (>height H1), and the distance from the lower end of the right deforming portion 7RT to the movable-side magnetic member 6 in the Z-axis direction is a height H3 (>height H2). When the movable-side member MB vibrates and displaces to the right, the lower part of the movable-side member MB (a lower portion EPR of the S-pole portion of the right magnet 5R) is located above the right deforming portion 7RT, as illustrated in the lower diagram in FIG. 8. Therefore, the movable-side member MB and the right deforming portion 7RT do not interfere with each other.

With this configuration, the vibration generator 101 can achieve miniaturization in the left-right direction (Y-axis direction) while securing the vibration power. This is because there is no need to provide a space for accommodating the right deforming portion 7RT on the right side (Y2 side) of the movable-side member MB. This is also because the vibration generator 101 can move (vibrate) the movable-side member MB rightward to the position where the right end of the movable-side member MB and the right deforming portion 7RT overlap in the top view.

Furthermore, this configuration can increase the maximum amplitude as compared with the spring disclosed in Japanese Laid-Open Patent Application No. 2010-207725 when other conditions such as the length in the left-right direction (Y-axis direction) are the same. Alternatively, this configuration can increase the volume of the movable-side member MB as compared with the spring disclosed in Japanese Laid-Open Patent Application No. 2010-207725 when other conditions such as the length in the left-right direction (Y-axis direction) are the same.

Furthermore, as illustrated in the top view of FIG. 3, the right deforming portion 7RT may include the first right deforming portion 7R2 having one end connected to the right standing portion 7R1 and extending on one side (rear, X2 direction) in the front-rear direction (X-axis direction), a right bent portion 7R3 to which the other end of the first right deforming portion 7R2 is connected, and the second right deforming portion 7R4 having one end connected to the right bent portion 7R3 and extending on the other side (forward, X1 direction) in the front-rear direction (X-axis direction) and having the other end connected to the right fixed portion 7R5.

With this configuration, the vibration generator 101 can be miniaturized in the front-rear direction (X-axis direction). This is because the length of the right deforming portion 7RT in the front-rear direction (X-axis direction) to achieve a desired spring constant of the right elastic support 7R can be shortened as compared with a case where the right bent portion 7R3 is not provided.

Furthermore, as illustrated in the top view of FIG. 3, the left elastic support 7L may include the left fixed portion 75 fixed to the fixed-side member FB (cover 1), the left deforming portion 7LT having one end connected to the left fixed portion 7L5 and extending in the front-rear direction (X-axis direction), and the left standing portion 7L1 extending in the vertical direction (Z-axis direction) from the other end of the left deforming portion 7LT. As illustrated in the upper drawing of FIG. 5, the movable-side member MB (the movable-side magnetic field generator 5 and the movable-side magnetic member 6) is attached to the left elastic support 7L to be disposed on the right side (Y2 side) of the left standing portion 7L1 at a position higher than the height H1 of the upper end of the left deforming portion 7LT. The height H1 is the distance from the lower end of the left deforming portion 7LT to the upper end of the left deforming portion 7LT in the Z-axis direction. The distance from the lower end of the left deforming portion 7LT to the movable-side magnetic field generator 5 (left magnet 5L) in the Z-axis direction is the height H2 (>height H1), and the distance from the lower end of the left deforming portion 7LT to the movable-side magnetic member 6 in the Z-axis direction is the height H3 (>height H2). When the movable-side member MB vibrates and displaces to the left, the lower part of the movable-side member MB (a lower portion EPL of the N-pole portion of the left magnet 5L) is located above the left deforming portion 7LT, as illustrated in the upper diagram in FIG. 8. Therefore, the movable-side member MB and the left deforming portion 7LT do not interfere with each other.

With this configuration, the vibration generator 101 can achieve further miniaturization in the left-right direction (Y-axis direction) while securing the vibration power. This is because it is not necessary to provide a space for accommodating the right deforming portion 7RT on the right side (Y2 side) of the movable-side member MB, and also, it is not necessary to provide a space for accommodating the left deforming portion 7LT on the left side (Y1 side) of the movable-side member MB. Moreover, the vibration generator 101 can move (vibrate) the movable-side member MB rightward to a position where the right end of the movable-side member MB and the right deforming portion 7RT overlap in the top view, and can move (vibrate) the movable-side member MB leftward to a position where the left end of the movable-side member MB and the left deforming portion 7LT overlap in the top view.

Furthermore, as illustrated in the top view of FIG. 3, the left deforming portion 7LT may include the first left deforming portion 7L2 having one end connected to the left standing portion 7L1 and extending on one side (forward, X1 direction) in the front-rear direction (X-axis direction), the left bent portion 7L3 to which the other end of the first left deforming portion 7L2 is connected, and the second left deforming portion 7L4 having one end connected to the left bent portion 7L3 and extending on the other side (rear, X2 direction) in the front-rear direction (X-axis direction) and having the other end connected to the left fixed portion 7L5.

With this configuration, the vibration generator 101 can be further miniaturized in the front-rear direction (X-axis direction). This is because the length of the left deforming portion 7LT in the front-rear direction (X-axis direction) to achieve the desired spring constant of the left elastic support 7L can be shortened as compared with the case where the left bent portion 7L3 is not provided.

The fixed-side magnetic field generator (coil 4) may be disposed below the movable-side member MB at position between the right elastic support 7R and the left elastic support 7L, as illustrated in the lower diagram of FIG. 6.

With this configuration, the vibration generator 101 can be further miniaturized in the left-right direction (Y-axis direction) while securing the vibration power. This is because it is not necessary to provide a space for accommodating the fixed-side magnetic field generator (coil 4) on either the left side (Y1 side) or the right side (Y2 side) of the movable-side member MB.

The elastic support 7 may include the connecting plate portion (center portion 7C) that connects the upper end of the right standing portion 7R1 and the upper end of the left standing portion 7L1. In this case, the movable-side magnetic member 6 may be attached below the connecting plate portion (center portion 7C).

With this configuration, the vibration generator 101 can increase the joint strength between the elastic support 7 and the movable-side member MB by welding or the like. This is because the elastic support 7 and the movable-side member MB are joined via the connecting plate portion (center portion 7C) which is relatively hard to deform. Moreover, this configuration has the effect that the number of parts can be reduced, and consequently, the number of welding positions can be reduced.

Furthermore, as illustrated in the lower diagram of FIG. 1, the fixed-side member FB may include the box casing (housing HS) including the cylindrical portion 1A provided with the front plate 1A1, the left plate 1A2, the rear plate 1A3, and the right plate 1A4, the bottom plate (base plate 2) connected to the lower end of the cylindrical portion 1A, and the top plate 1B connected to the upper end of the cylindrical portion 1A.

This configuration has the effect that the magnetic field generated by each of the fixed-side magnetic field generator (coil 4) and the movable-side magnetic field generator 5 can be prevented or substantially prevented from magnetic interference with other devices located outside the vibration generator 101.

The vibration generator described above can suppress an increase in size in the vibration direction.

Thus, the preferred embodiments of the present disclosure have been described in detail. However, the present invention is not limited to the above-described embodiments. The above-described embodiments can be modified, replaced, or the like without departing from the scope of the present invention. Each of the features described with reference to the above-described embodiments may be suitably combined as long as there is no technical contradiction.

For example, in the above-described embodiments, the vibration generator 101 is configured to include the left magnet 5L and the right magnet 5R as the movable-side magnetic field generator and the coil 4 as the fixed-side magnetic field generator. However, the vibration generator 101 may be configured to include a coil as the movable-side magnetic field generator and a permanent magnet as the fixed-side magnetic field generator. The vibration generator 101 may be configured to include a coil as the movable-side magnetic field generator and the coil 4 as the fixed-side magnetic field generator.

What is claimed is:

1. A vibration generator, comprising:
a fixed-side member;
a movable-side member;
an elastic support configured to support the movable-side member to vibrate in a left-right direction with respect to the fixed-side member; and
a driver configured to impart a vibration force in the left-right direction to the movable-side member, the driver being provided with a fixed-side magnetic field generator included in the fixed-side member and a movable-side magnetic field generator included in the movable-side member, wherein
the elastic support includes a left elastic support and a right elastic support,
the right elastic support includes a right fixed portion fixed to the fixed-side member, a right deforming portion having one end connected to the right fixed portion and extending in a front-rear direction, and a right standing portion extending in a vertical direction from another end of the right deforming portion,
the right deforming portion deforms in the left-right direction upon vibration of the movable-side member in the left-right direction,
the right standing portion moves in the left-right direction together with the movable-side member upon deformation of the right deforming portion,
the movable-side member is attached to an upper end of the right standing portion, or a connecting plate portion connecting an upper end of the left elastic support and an upper end of the right elastic support, so as to be arranged on a left side of the right standing portion and at a position above an upper end of the right deforming portion,
upon vibration and displacement of the movable-side member to a right side, a lower portion of the movable-side member is at a position above the right deforming portion and not interfering with the right deforming portion,
the right deforming portion extends in the front-rear direction from a front end or a rear end of the right standing portion, and
a length of the right deforming portion in the front-rear direction is greater than a length of the right standing portion in the front-rear direction.

2. The vibration generator according to claim 1, wherein
the right deforming portion includes
a first right deforming portion having one end connected to the right standing portion and extending on one side in the front-rear direction;
a right bent portion to which another end of the first right deforming portion is connected; and
a second right deforming portion having one end connected to the right bent portion and extending on another side in the front-rear direction and having another end connected to the right fixed portion.

3. The vibration generator according to claim 1, wherein
the left elastic support includes
a left fixed portion fixed to the fixed-side member;
a left deforming portion having one end connected to the left fixed portion and extending in the front-rear direction; and
a left standing portion extending in the vertical direction from another end of the left deforming portion, wherein
the movable-side member is attached to the left elastic support so as to be arranged on a right side of the left standing portion and at a position above the left deforming portion, and
upon vibration and displacement of the movable-side member to the left side, the lower portion of the movable-side member is at a position above the left deforming portion and not interfering with the left deforming portion.

4. The vibration generator according to claim 3, wherein
the left deforming portion includes
a first left deforming portion having one end connected to the left standing portion and extending on one side in the front-rear direction;
a left bent portion to which another end of the first left deforming portion is connected; and
a second left deforming portion having one end connected to the left bent portion and extending on another side in the front-rear direction and having another end connected to the left fixed portion.

5. The vibration generator according to claim 3, wherein
the fixed-side magnetic field generator is disposed below the movable-side member at position between the right elastic support and the left elastic support.

6. The vibration generator according to claim 3, wherein
the elastic support includes the connecting plate portion that connects the upper end of the right standing portion and an upper end of the left standing portion, and
the movable-side magnetic field generator is attached to a lower side of the connecting plate portion.

7. The vibration generator according to claim 3, wherein
the fixed-side member includes a box casing including
a cylindrical portion provided with a front plate, a left plate, a rear plate, and a right plate;
a bottom plate connected to a lower end of the cylindrical portion; and
a top plate connected to an upper end of the cylindrical portion.

8. The vibration generator according to claim 1, wherein
the movable-side member is capable of being displaced rightward to a position where a right end of the movable-side member and the right deforming portion overlap in a top view, and
upon displacement of the movable-side member to the right side to a position where the right end of the movable-side member and the right deforming portion overlap in the top view, the lower portion of the movable-side member is at a position above the right deforming portion and not interfering with the right deforming portion.

9. The vibration generator according to claim 1, wherein
a distance from a lower end of the right deforming portion to the movable-side member in the vertical direction is greater than a distance from the lower end of the right deforming portion to the upper end of the right deforming portion in the vertical direction.

10. The vibration generator according to claim 1, wherein
the right standing portion is formed to extend vertically upward from the right deforming portion, and
the right deforming portion is disposed to the lower portion of the movable-side member in a right view in the left-right direction.
